(19) United States
(12) Patent Application Publication
(10) Pub. No.: US 2017/0062800 A1
(43) Pub. Date: Mar. 2, 2017

(54) MANUFACTURING METHOD FOR POLYCRYSTALLINE ELECTRODE

(71) Applicant: Institute of Nuclear Energy Research, Atomic Energy Council, Executive Yuan, R.O.C, Taoyuan (TW)

(72) Inventors: Tien-Hsiang HSUEH, New Taipei (TW); Chi-Hung SU, Taoyuan (TW); Der-Jun JAN, Taoyuan County (TW); Yuh-Jenq YU, Taoyuan (TW); Yuan-Ruei JHENG, Taoyuan (TW)

(21) Appl. No.: 14/989,230

(22) Filed: Jan. 6, 2016

(30) Foreign Application Priority Data
Aug. 28, 2015 (TW) 104128426

(51) Int. Cl. H01M 4/04; H01M 4/1397; H01M 4/1391

(52) U.S. Cl. CPC H01M 4/0471; H01M 4/0404; H01M 4/0407; H01M 4/0426; H01M 4/0423; H01M 4/1391; H01M 4/1397; H01M 2004/028

(57) ABSTRACT

A method for manufacturing polycrystalline electrode is provided, which may include the following steps: providing a conductive substrate; using a film coating method to deposit an active material on one side of the conductive substrate by a hydrogen-containing plasma source to form an electrode layer; executing a thermal annealing process for the electrode layer in an oxygen-containing environment. The grains of the polycrystalline electrode manufactured by the method will be more uniform in size, which can significantly increase the volumetric energy density of thin-film battery to significantly improve its performance.

### CROSS-REFERENCE TO RELATED APPLICATIONS

This application also claims priority to Taiwan Patent Application No. 104128426 filed in the Taiwan Patent Office on Aug. 28, 2015, the entire content of which is incorporated herein by reference.

### TECHNICAL FIELD

The present disclosure relates to a method for manufacturing an electrode, in particular to a method for manufacturing a polycrystalline electrode.

### BACKGROUND

Currently, thin-film battery has been comprehensively applied to the MEMS; the volumetric energy density is a very important indicator for assessing the performance of thin-film battery. Compared with a thin-film battery with low volumetric energy density, a thin-film battery with high volumetric energy density can be applied with a broad acceptance when their size is the same. Thus, how to increase the volumetric energy density of thin-film battery has become an important issue. For the purpose of effectively increasing the volumetric energy density of thin-film battery, the size of each grain of the active material film which serves as the electrode layer should be uniform and proper.

Please refer to FIG. 1, FIG. 2, and FIG. 3, which are the first schematic view, the second schematic view, and the third schematic view of a conventional polycrystalline electrode. FIG. 1 illustrates a most frequently-used active material film with non-uniform grains; as shown in FIG. 1, the grains of the upper layer of the film are obviously larger than the grains of the lower layer of the film in size; as the grains of the upper layer of the film are too large in size, the lithium ions cannot have enough time to move in and out of the lattices for intercalation and deintercalation. On the contrary, the grains of the lower layer of the film are too small in size, so the lithium ions cannot smoothly execute intercalation and deintermcalation. The above phenomenon will be more obvious if the thickness of the active material film is higher.

FIG. 2 illustrates the current-voltage diagram of the active material film with non-uniform grains, which obviously shows the current-voltage diagram of the active material film with non-uniform grains cannot show a complete oxidation peak and a complete reduction peak.

FIG. 3 illustrates the discharge diagram of the active material film with non-uniform grains, which obviously shows the volumetric energy density of the active material film with non-uniform grains is far from the theoretical value.

Some patent literatures have proposed methods for manufacturing active materials with high volumetric energy density; however, the active materials used by these patent literatures are powder, so the active material films formed by these active materials will have a lot of voids; as a result, the volumetric energy density of the thin-film batteries will also be far from the theoretical value.

Other relevant patent literatures, such as U.S. Pat. No. 8,673,490, U.S. Pat. No. 8,920,974, Taiwan Patent Publication No. 404078, and Taiwan Patent Publication No. 1349388 also have the above problems.

### SUMMARY

The present disclosure is related to a method for manufacturing polycrystalline electrode. In one embodiment of the present invention, the method may include the following steps: providing a conductive substrate; using a film coating method to deposit an active material on one side of the conductive substrate by a hydrogen-containing plasma source to form an electrode layer; executing a thermal annealing process for the electrode layer in an oxygen-containing environment.

In a preferred embodiment of the present invention, the method further includes the following step: forming an electrolyte layer on the first electrode layer.

In a preferred embodiment of the present invention, the method further includes the following step: using the film coating method to deposit the active material on the electrolyte layer by the hydrogen-containing plasma source to form a second electrode layer; and executing the thermal annealing process to process the second electrode layer in the oxygen-containing environment to make the grains of the second electrode layer uniform.

In a preferred embodiment of the present invention, the method further includes the following step: forming a current collecting layer on the second electrode layer.

In a preferred embodiment of the present invention, the method further includes the following step: forming a first conductive film between the conductive substrate and the first electrode layer.

In a preferred embodiment of the present invention, the method further includes the following step: forming a second conductive film between the second electrode layer and the current collecting layer.

In a preferred embodiment of the present invention, the conductive film may be a graphite film.

In a preferred embodiment of the present invention, the conductive substrate may be a metal substrate.

In a preferred embodiment of the present invention, the metal substrate may be a stainless steel substrate, an aluminum substrate, a nickel substrate, or a copper substrate.

In a preferred embodiment of the present invention, the hydrogen-containing plasma source is the mixed gas of an inert gas and a gas including hydrogen atoms.

In a preferred embodiment of the present invention, the gas including hydrogen atoms may be hydrogen gas, ammonia gas, or methane gas.

In a preferred embodiment of the present invention, the inert gas may be helium gas, neon gas, argon gas, krypton gas, xenon gas, and radon gas.

In a preferred embodiment of the present invention, the volume ratio of the gas including hydrogen atoms to the inert gas may be in the range of 0.001˜0.1.

In a preferred embodiment of the present invention, the active material may be LiCoO₂, LiNiO₂, LiMn₂O₄, LiAl_{0.1}Mn_{1.9}O₄, LiFePO₄, or Li₄Ti₅O₁₂.

In a preferred embodiment of the present invention, the size of each of the grains of the first electrode layer may be in the range of 50 nm˜500 nm.

In a preferred embodiment of the present invention, the thickness of the first electrode layer may be in the range of 50 nm˜5000 nm.

In a preferred embodiment of the present invention, the film coating method may be the vacuum thermal evaporation, the radio frequency sputtering, or the radio frequency magnetron sputtering.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is the first schematic view of the conventional polycrystalline electrode.

FIG. 2 is the second schematic view of the conventional polycrystalline electrode.

FIG. 3 is the third schematic view of the conventional polycrystalline electrode.

FIG. 4 is the first schematic view of the first embodiment of the thin-film battery in accordance with the present invention.

FIG. 5 is the second schematic view of the first embodiment of the thin-film battery in accordance with the present invention.

FIG. 6 is the third schematic view of the first embodiment of the thin-film battery in accordance with the present invention.

FIG. 7 is the fourth schematic view of the first embodiment of a thin-film battery in accordance with the present invention.

FIG. 8 is the flow chart of the first embodiment of the thin-film battery in accordance with the present invention.

FIG. 9 is the schematic view of the second embodiment of the thin-film battery in accordance with the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Please refer to FIG. 4, which is the first schematic view of the first embodiment of the thin-film battery in accordance with the present invention. As shown in FIG. 4, the polycrystalline electrode 1 may include a conductive substrate 10, a first electrode layer 11, an electrolyte layer 12, a second electrode layer 13, and a current collecting layer 14.

The conductive substrate 10 may be a metal substrate, such as a stainless steel substrate, an aluminum substrate, a nickel substrate, or a copper substrate. The first electrode layer 11 may be an active material film with grains, which can be formed on the conductive substrate 10; the above active material may be LiCoO₂, LiNiO₂, LiMn₂O₄, LiAl_{0.1}Mn_{1.9}O₄, LiFePO₄, or Li₄Ti₅O₁₂. The electrolyte layer 12 may be formed on the first electrode layer 11 (the cathode or the anode). The second electrode layer 13 (the cathode or the anode) may be formed on the electrolyte layer 12. The current collecting layer 14 may be formed on the second electrode layer 13.

In the embodiment, a film coating method may be used to manufacture the first electrode layer 11; the film coating method can deposit the active material on one side of the conductive substrate 10 by a hydrogen-containing plasma source to form the first electrode layer 11; in this way, part of the oxygen atoms can be removed from the active material; then, the first electrode layer 11 may be processed by a thermal annealing process to make the first electrode layer 11 become uniform grains; the grains may be laminar, spinal-shaped, or olivine-shaped, and have 2D or 3D structure. Similarly, the second electrode layer 13 may be manufactured by the above process. More specifically, the hydrogen-containing plasma source may be the mixed gas of an inert gas and a gas including hydrogen atoms; the gas including hydrogen atoms may be hydrogen gas, ammonia gas, or methane gas; the inert gas may be helium gas, neon gas, argon gas, krypton gas, xenon gas, and radon gas; the volume ratio of the gas including hydrogen atoms to the inert gas may be in the range of 0.001˜0.1; the film coating method may be a vacuum thermal evaporation, a radio frequency sputtering, or a radio frequency magnetron sputtering, etc.

Besides, there may be a conductive film formed between the first electrode layer 11 and the conductive substrate 10, and between the second electrode layer 13 and the current collecting layer 14 respectively; the conductive film may be a graphite film and the like, which can further improve the electrochemical performance and the stability of the active material.

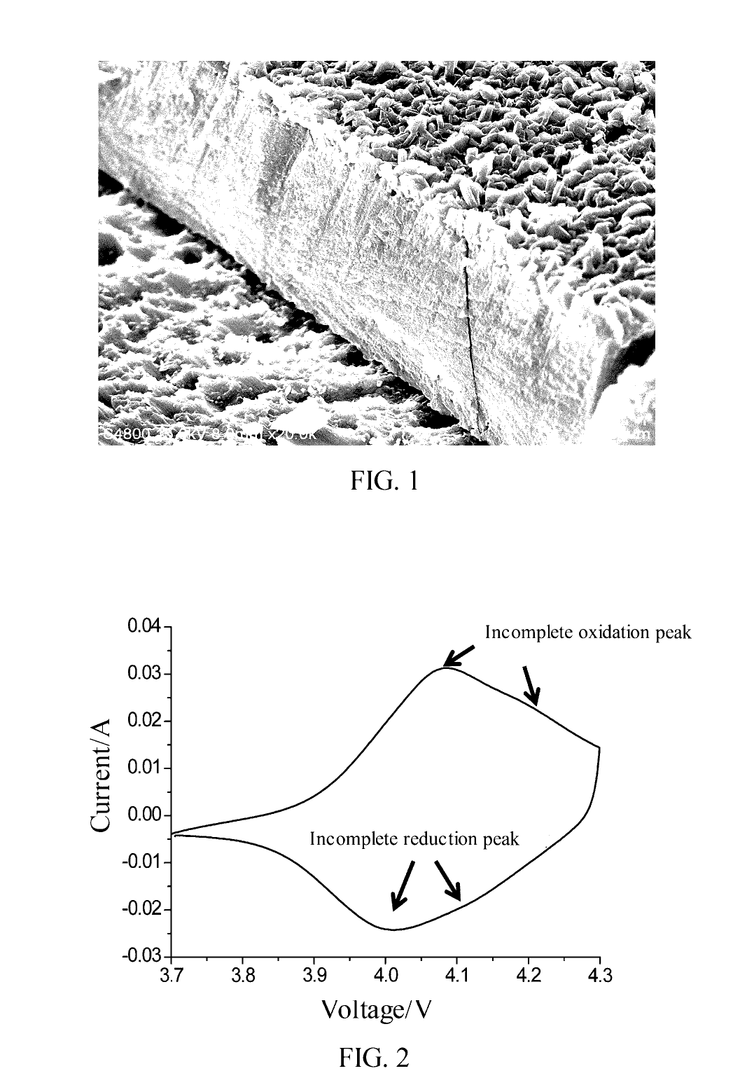

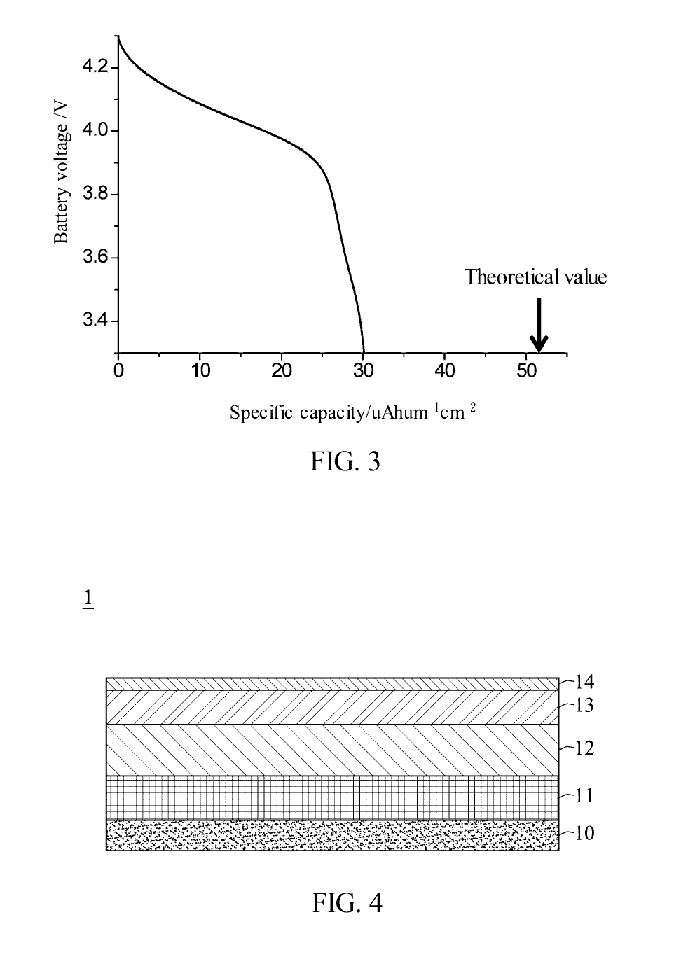

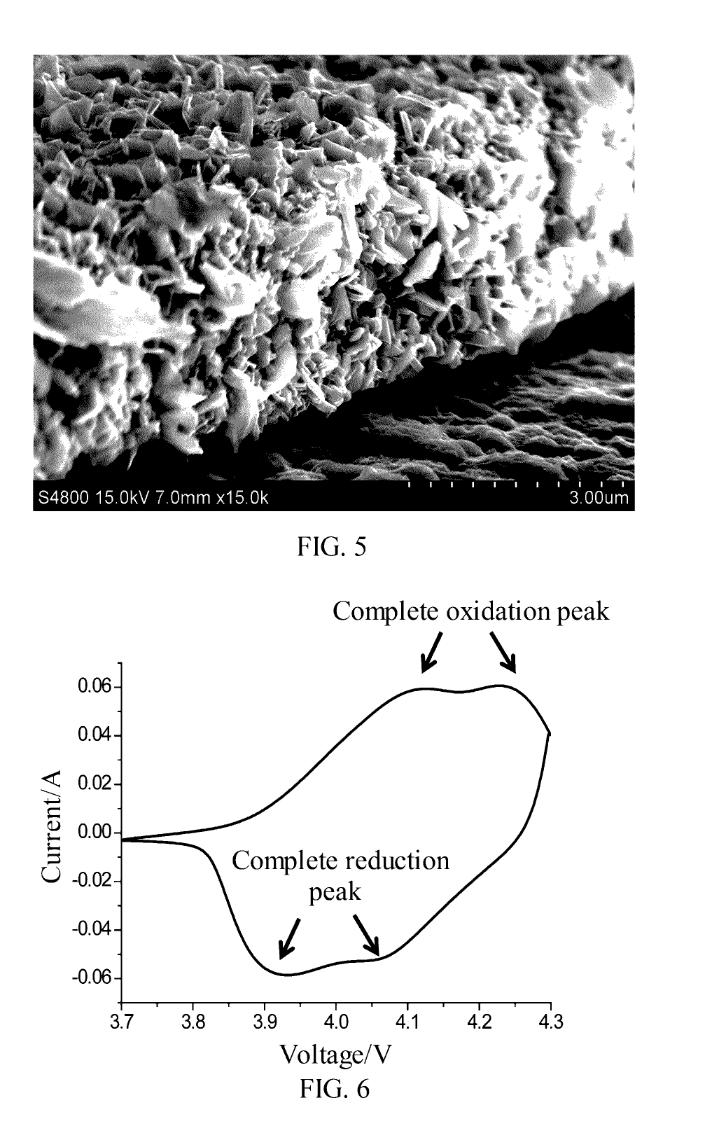

Please refer to FIG. 5, which is the second schematic view of the first embodiment of the thin-film battery in accordance with the present invention; FIG. 5 illustrates the cross-sectional view of the electrode layer of the embodiment. In general, the active material film can serve as the electrode layer after processed by the thermal annealing process; however, the non-uniform grains will be formed after the thermal annealing process; that is to say, the grains of the upper layer of the film will be much larger than the grains of the lower layer of the film, as shown in FIG. 1.

However, the embodiment adopts a special processing technology, which uses a film coating method to deposit the active material on one side of the conductive substrate by a hydrogen-containing plasma source to form the electrode layer, which can effectively remove part of the oxygen atoms from the active material; afterward, the electrode layer is processed by the thermal annealing process to make the active material film having uniform grains; as shown in FIG. 5, the grains of the upper layer, the central layer, and the lower layer of the active material film are very uniform. Additionally, since the above process can make the grains of the active material film uniform, the thickness of the active material film for serving as electrode layer can be increased; in a preferred embodiment, the thickness of the active material film can be about 50 nm˜5000 nm.

Besides, the size of each of the grains of the active material film manufactured by the process can be more appropriate, which may be about 50 nm˜500 nm so as to facilitate the intercalation and the deintercalation of the lithium ions. As a result, the volumetric energy density of the thin-film battery may be further increased.

Please refer to FIG. 6, which is the third schematic view of the first embodiment of the thin-film battery in accordance with the present invention; FIG. 6 illustrates the current-voltage diagram of the electrode layer of the embodiment.

As shown in FIG. 6, in the embodiment, the uniform grains can be formed after the active material film for serving as electrode layer is processed by the thermal annealing process; accordingly, the current-voltage diagram of the active material film can show a complete oxidation peak and a complete reduction peak.

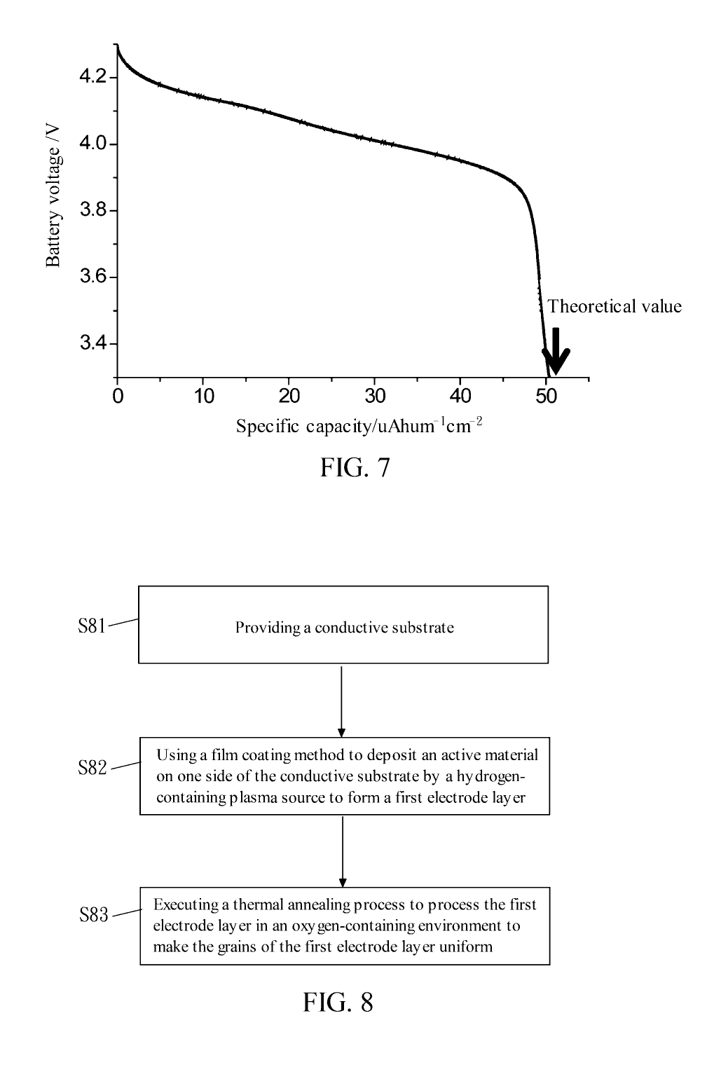

Please refer to FIG. 7, which is the fourth schematic view of the first embodiment of the thin-film battery in accordance with the present invention; FIG. 7 illustrates the discharge diagram of the electrode layer of the embodiment.

As shown in FIG. 7, in the embodiment, the uniform grains can be formed after the active material film for serving as electrode layer is processed by the thermal annealing process; accordingly, the volumetric energy density of the active material film can be effectively increased; as shown in FIG. 7, the volumetric energy density of the active material film is very close to the theoretical value.

It is worthy to point out that as the polycrystalline electrode of conventional thin-film battery cannot have uniform grains, and the size of the grains is also improper, the lithium ions cannot smoothly execute intercalation and deintermcalation; accordingly, the volumetric energy density of the polycrystalline electrode cannot be effectively increased. Besides, although some patent literatures have proposed methods for manufacturing active materials with high volumetric energy density; however, the active materials used by these patent literatures are powder, so the active material films formed by these active materials will still have a large number of voids; as a result, the volumetric energy density of the thin-film batteries will also be far from the theoretical value. On the contrary, in the embodiments of the present invention, a special processing technology is used to process the active material film, so the active material film for serving as electrode layer will have uniform grains with proper size; therefore, the lithium ions can smoothly execute intercalation and deintermcalation, which can significantly increase the volumetric energy density of the thin-film battery and dramatically reduce the cost of the thin-film battery.

Moreover, the polycrystalline electrode of conventional thin-film battery does not have uniform grains, so the effective thickness of the polycrystalline electrode will be limited. On the contrary, in the embodiments of the present invention, the active material film for serving as electrode layer can be processed by a special processing technology, so the uniform grains with proper size can be formed after the active material film is processed by the thermal annealing process; thus, the processing technology can be used to manufacture the electrode layer with greater thickness.

As the active material film for serving as electrode layer can have uniform grains, so its volumetric energy density can be significantly increased; thus, compared with conventional thin-film battery with low volumetric energy density, the thin-film battery according to the embodiments of the present invention can be can be applied with a broad acceptance when their size is the same. Thus, the commercial value of the thin-film battery can be significantly increased.

Furthermore, the method for manufacturing polycrystalline electrode according to the embodiments of the present invention can form a conductive film between the conductive substrate and the electrode layer, which can further better and stabilize the electrochemical performance of the active material film so as to improve the performance of the thin-film battery. As described above, the present invention definitely has an inventive step.

Please refer to FIG. 8, which is the flow chart of the first embodiment of the thin-film battery in accordance with the present invention. The embodiment may include the following steps:

In the step S81, providing a conductive substrate.

In the step S82, using a film coating method to deposit an active material on one side of the conductive substrate by a hydrogen-containing plasma source to form a first electrode layer.

In the step S83, executing a thermal annealing process to process the first electrode layer in an oxygen-containing environment to make the grains of the first electrode layer uniform.

The embodiment may further include the following steps: forming an electrolyte layer on the first electrode layer; using the film coating method to deposit the active material on the electrolyte layer by the hydrogen-containing plasma source to form a second electrode layer; executing the thermal annealing process to process the second electrode layer in the oxygen-containing environment to make the grains of the second electrode layer uniform; forming a current collecting layer on the second electrode layer; forming a first conductive film between the conductive substrate and the first electrode layer; and forming a second conductive film between the second electrode layer and the current collecting layer.

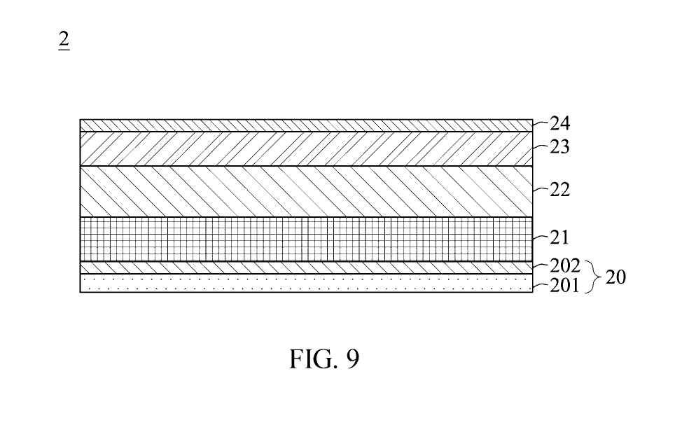

Please refer to FIG. 9, which is the schematic view of the second embodiment of the thin-film battery in accordance with the present invention. As shown in FIG. 9, the polycrystalline electrode 2 may include a conductive substrate 20, a first electrode layer 21, an electrolyte layer 22, a second electrode layer 23, and a current collecting layer 24.

The difference between the embodiment and the previous embodiment is that the conductive substrate 20 may include an isolation substrate 201 and a current collecting layer 202. The first electrode layer 21 may be an active material film with grains, which can be formed on the conductive substrate 20; as described above, the active material may be LiCoO₂, LiNiO₂, LiMn₂O₄, LiAl_{0.1}Mn_{1.9}O₄, LiFePO₄, or Li₄Ti₅O₁₂. The electrolyte layer 22 may be formed on the first electrode layer 21. The second electrode layer 23 may be formed on the electrolyte layer 22. The current collecting layer 24 may be formed on the second electrode layer 23.

Similarly, a film coating method may be used to manufacture the first electrode layer 21; the film coating method can deposit the active material on one side of the conductive substrate 20 by a hydrogen-containing plasma source to form the first electrode layer 21; in this way, part of the oxygen atoms can be removed from the active material; then, the first electrode layer 21 may be processed by a thermal annealing process to make the first electrode layer 21 become uniform grains; the grains may be laminar, spinal-shaped, or olivine-shaped, and have 2D or 3D structure. Similarly, the second electrode layer 23 may be manufactured by the above process. More specifically, the hydrogen-containing plasma source may be the mixed gas of an inert gas and a gas including hydrogen atoms; the gas including hydrogen atoms may be hydrogen gas, ammonia gas, or methane gas; the inert gas may be helium gas, neon gas, argon gas, krypton gas, xenon gas, and radon gas; the volume ratio of the gas including hydrogen atoms to the inert gas may be in the range of 0.001˜0.1; the film coating method may be a vacuum thermal evaporation, a radio frequency sputtering, or a radio frequency magnetron sputtering, etc.

Similarly, there may be a conductive film formed between the first electrode layer 21 and the conductive substrate 20, and between the second electrode layer 23 and the current collecting layer 24 respectively; the conductive film may be a graphite film and the like, which can further improve the electrochemical performance and the stability of the active material. The detailed manufacturing method and the other technical features of the embodiment are similar to the previous embodiment, so which will not be described herein.

In summation of the description above, in one embodiment of the present invention, the method for manufacturing polycrystalline electrode can make the whole electrode layer have uniform grains, which can significantly increase the volumetric energy density of the electrode layer and improve its performance.

Also, in one embodiment of the present invention, the method for manufacturing polycrystalline electrode can make the whole electrode layer can make the grains of the electrode layer have proper size, which can further increase the volumetric energy density of the electrode layer and further improve its performance.

In one embodiment of the present invention, the method for manufacturing polycrystalline electrode can form a conductive film between the conductive substrate and the electrode layer, which can stabilize and better the electrochemical performance of the active material film for serving as electrode layer so as to enhance the performance of the thin-film battery.

Besides, in one embodiment of the present invention, the method for manufacturing polycrystalline electrode can increase the volumetric energy density of the electrode layer, which can significantly reduce the cost of the thin-film battery.

Furthermore, in one embodiment of the present invention, the active material film can have uniform grains, which can significantly increase the volumetric energy density of the electrode layer; thus, compared with conventional thin-film battery with low volumetric energy density, the thin-film battery according to the embodiments of the present invention can be applied with a broad acceptance when their size is the same. For the reason, the commercial value of the thin-film battery can be significantly increased.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A manufacturing method for a polycrystalline electrode, comprising:
providing a conductive substrate;
using a film coating method to deposit an active material on one side of the conductive substrate by a hydrogen-containing plasma source to form a first electrode layer; and
executing a thermal annealing process to process the first electrode layer in an oxygen-containing environment to make grains of the first electrode layer uniform.

2. The manufacturing method for the polycrystalline electrode of claim 1, further comprising:
forming an electrolyte layer on the first electrode layer.

3. The manufacturing method for the polycrystalline electrode of claim 2, further comprising:
using the film coating method to deposit the active material on the electrolyte layer by the hydrogen-containing plasma source to form a second electrode layer; and
executing the thermal annealing process to process the second electrode layer in the oxygen-containing environment to make grains of the second electrode layer uniform.

4. The manufacturing method for the polycrystalline electrode of claim 3, further comprising:
forming a current collecting layer on the second electrode layer.

5. The manufacturing method for the polycrystalline electrode of claim 4, further comprising:
forming a first conductive film between the conductive substrate and the first electrode layer.

6. The manufacturing method for the polycrystalline electrode of claim 5, further comprising:
forming a second conductive film between the second electrode layer and the current collecting layer.

7. The manufacturing method for the polycrystalline electrode of claim 6, wherein the conductive film is a graphite film.

8. The manufacturing method for the polycrystalline electrode of claim 1, wherein the conductive substrate is a metal substrate.

9. The manufacturing method for the polycrystalline electrode of claim 8, wherein the metal substrate is a stainless steel substrate, an aluminum substrate, a nickel substrate, or a copper substrate.

10. The manufacturing method for the polycrystalline electrode of claim 1, wherein the hydrogen-containing plasma source is a mixed gas of an inert gas and a gas comprising hydrogen atoms.

11. The manufacturing method for the polycrystalline electrode of claim 10, wherein the gas comprising hydrogen atoms is a hydrogen gas, an ammonia gas, or a methane gas.

12. The manufacturing method for the polycrystalline electrode of claim 10, wherein the inert gas is a helium gas, a neon gas, an argon gas, a krypton gas, a xenon gas, and a radon gas.

13. The manufacturing method for the polycrystalline electrode of claim 10, wherein a volume ratio of the gas comprising hydrogen atoms to the inert gas is in a range of 0.001˜0.1.

14. The manufacturing method for the polycrystalline electrode of claim 1, wherein the active material is LiCoO₂, LiNiO₂, LiMn₂O₄, LiAl_{0.1}Mn_{1.9}O₄, LiFePO₄, or Li₄Ti₅O₁₂.

15. The manufacturing method for the polycrystalline electrode of claim 1, wherein a size of each of the grains of the first electrode layer is in a range of 50 nm˜500 nm.

16. The manufacturing method for the polycrystalline electrode of claim 1, wherein a thickness of the first electrode layer is in a range of 50 nm˜5000 nm.

17. The manufacturing method for the polycrystalline electrode of claim 1, wherein the film coating method is a vacuum thermal evaporation, a radio frequency sputtering, or a radio frequency magnetron sputtering.
